(19) United States
(12) Patent Application Publication
(10) Pub. No.: US 2021/0398004 A1
(43) Pub. Date: Dec. 23, 2021

(54) METHOD AND APPARATUS FOR ONLINE BAYESIAN FEW-SHOT LEARNING

(71) Applicant: Electronics and Telecommunications Research Institute, Daejeon (KR)

(72) Inventors: Hyun Woo KIM, Daejeon (KR); Gyeong Moon PARK, Daejeon (KR); Jeon Gue PARK, Daejeon (KR); Hwa Jeon SONG, Daejeon (KR); Byung Hyun YOO, Daejeon (KR); Eui Sok CHUNG, Daejeon (KR); Ran HAN, Daejeon (KR)

(73) Assignee: Electronics and Telecommunications Research Institute, Daejeon (KR)

(21) Appl. No.: 17/353,136

(22) Filed: Jun. 21, 2021

(30) Foreign Application Priority Data
Jun. 19, 2020 (KR) 10-2020-0075025

(51) Int. Cl. G06N 7/00; G06N 3/04; G06N 3/08

(52) U.S. Cl. CPC G06N 7/005; G06N 3/08; G06N 3/04

(57) ABSTRACT

Provided are a method and apparatus for online Bayesian few-shot learning. The present invention provides a method and apparatus for online Bayesian few-shot learning in which multi-domain-based online learning and few-shot learning are integrated when domains of tasks having data are sequentially given.

### CROSS-REFERENCE TO RELATED APPLICATION

This application claims priority to and the benefit of Korean Patent Application No. 10-2020-0075025, filed on Jun. 19, 2020, the disclosure of which is incorporated herein by reference in its entirety.

### BACKGROUND

### 1. Field of the Invention

The present invention relates to a method and apparatus for online Bayesian few-shot learning, and more particularly, to a method and apparatus for online Bayesian few-shot learning in which multi-domain-based online learning and few-shot learning are integrated.

### 2. Discussion of Related Art

Current deep learning technologies require diverse and high-quality data and enormous computing resources required for model learning. On the other hand, humans can learn quickly and efficiently. A technology for learning a new task using only a small amount of data, such as human learning, is called a few-shot learning technology.

The few-shot learning technology is based on meta learning that performs “learning about a learning method.” In addition, it is possible to quickly learn with a small amount of data by learning new concepts and rules through training tasks similar to actual tasks having a small amount of data.

Meanwhile, offline learning is learning performed with all pieces of data given at once, and online learning is learning performed with pieces of data given sequentially. Among those, multi-domain online learning refers to learning a model when domains are sequentially given.

However, in the multi-domain online learning, when a new domain is learned, a phenomenon of forgetting the past domain occurs. In order to alleviate the forgetting phenomenon, continuous learning technologies such as a normalization-based method, a rehearsal-based method, and a dynamic network structure-based method are used, but there is no method of integrating online learning and few-shot learning.

### SUMMARY OF THE INVENTION

The present invention is directed to providing a method and apparatus for online Bayesian few-shot learning in which multi-domain-based online learning and few-shot learning are integrated when domains of tasks having a small amount of data are sequentially given.

However, the technical problems to be achieved by the embodiments of the present invention are not limited to the technical problems as described above, and other technical problems may exist.

According to an aspect of the present invention, there is provided a method of online Bayesian few-shot learning, in which multi-domain-based online learning and few-shot learning are integrated, the method including: a domain and a task based on context information of all pieces of input support data, acquiring modulation information of an initial parameter of a task execution model based on the estimated domain and task, modulating the initial parameter of the task execution model based on the modulation information, normalizing the modulated parameter of the task execution model, adapting the normalized parameter of the task execution model to all pieces of the support data, calculating a task execution loss by performing a task on an input of query data using the adapted parameter of the task execution model, acquiring a logit pair for the support data and the input of the query data, calculating a contrast loss based on the acquired logit pair, calculating a total loss based on the task execution loss and the contrast loss, and updating the initial parameters of the entire model using the total loss as a reference value.

The estimating of the domain and task based on the context information of all pieces of the input support data may include performing batch sampling based on at least one task in a previous domain and a current domain consecutive to the previous domain, extracting features of the support data corresponding to each of the sampled tasks, performing embedding in consideration of context information of the extracted features, and estimating the domain and the task of the support data based on embedded feature information according to the embedding result.

The performing of the embedding in consideration of the context information of the extracted features may include setting the extracted feature as an input of a self-attention model composed of multi layers and acquiring the embedded feature information as an output corresponding to the input.

The performing of the embedding in consideration of the context information of the extracted features may include setting the extracted feature as an input of a bidirectional long short-term memory (BiLSTM) model composed of the multi layers and acquiring the embedded feature information as the output corresponding to the input.

The estimating of the domain and the task of the support data based on the embedded feature information according to the embedding result may include setting the embedding feature information as an input of a multi-layer perceptron model and acquiring the area and the task of the estimated support data as the output corresponding to the input. A dimension of an output stage for the output may be set to be smaller than a dimension of an input stage for the input.

The acquiring of the modulation information of the initial parameter of a task execution model based on the estimated domain and task may include acquiring the modulation information of the initial parameter of a task execution model from a knowledge memory by using the estimated domain and task.

The acquiring of the modulation information of the initial parameter of a task execution model based on the estimated domain and task may include setting the estimated domain and task as an input of a BiLSTM model or a multi-layer perceptron model and generating a read_query and a write_query required for accessing the knowledge memory as an output corresponding to the input.

The acquiring of the modulation information of the initial parameter of a task execution model based on the estimated domain and task may include calculating a weight for a location of the knowledge memory using the read_query and acquiring the modulation information of the initial parameter of the task execution model by a linear combination with a value stored in the knowledge memory through the weight.

The calculating of the weight for the location of the knowledge memory using the read_query may further include deleting the value stored in the knowledge memory based on the weight, and adding and updating the modulation information of the estimated domain and task.

In the acquiring of the modulation information of the initial parameter of the task execution model based on the estimated domain and task, the modulation information of the initial parameter of the task execution model may be acquired from the estimated domain and task.

In the modulating of the initial parameter of the task execution model based on the modulation information, a variable size constant or a convolution filter may be used as the modulation information.

In the adapting of the normalized parameter of the task execution model to all pieces of the support data, the adaptation of the normalized parameter of the task execution model to all pieces of the support data may be performed based on a probabilistic gradient decent method.

In the performing of the task on the input of the query data using the adapted parameter of the task execution model, the task may be performed by applying a Bayesian neural network to the input of the query data.

The acquiring of the logit pair for all pieces of the support data and the input of the query data may include acquiring the logit pair for all pieces of the support data and the input of the query data as the initial parameters of the entire model of the previous domain and a current domain consecutive to the previous domain.

The calculating of the contrast loss based on the acquired logit pair may include determining whether the acquired logit pair is generated as the same data, and calculating the contrast loss based on an error according to the determination result.

According to another aspect of the present invention, there is provided an apparatus for online Bayesian few-shot learning in which multi-domain-based online learning and few-shot learning are integrated, the apparatus including: a memory configured to store a program for multi-domain-based online learning and few-shot learning, and a processor configured to execute the program stored in the memory, in which the processor may be configured to estimate a domain and a task based on context information of all pieces of input support data, and acquire modulation information of an initial parameter of a task execution model based on the estimated domain and task, and then modulate the initial parameter of the task execution model based on the modulation information according to an execution of the program, normalize the parameter of the modulated task execution model, adapt the normalized parameter to all pieces of the support data, and calculate a task execution loss by performing the task on the input of the query data using the adapted parameter of the task execution model, and acquire a logit pair for all pieces of the support data and the input of the query data, calculate a contrast loss based on the acquired logit pair, calculate a total loss based on the task execution loss and the contrast loss, and then update the initial parameters of the entire model using the total loss as a reference value.

According to still another aspect of the present invention, there is provided an apparatus for online Bayesian few-shot learning in which multi-domain-based online learning and few-shot learning are integrated, the apparatus including a domain and task estimator configured to estimate a domain and a task based on context information of all pieces of input support data, a modulation information acquirer configured to acquire modulation information of an initial parameter of a task execution model based on the estimated domain and task, a modulator configured to modulate the initial parameter of the task execution model based on the modulation information, a normalization unit configured to normalize the modulated parameter of the task execution model, a task execution adaptation unit configured to adapt the normalized parameter of the task execution model to all pieces of the support data, a task executor configured to calculate a task execution loss by performing a task on an input of query data using the adapted parameter of the task execution model, and a determination and update unit configured to acquire a logit pair for all pieces of the support data and the input of the query data, calculate a contrast loss based on the acquired logit pair, calculate a total loss based on the task execution loss and the contrast loss, and then update the initial parameters of the entire model using the total loss as a reference value.

The modulation information acquirer may acquire the modulation information of the initial parameter of the task execution model directly from the estimated domain and task or from a knowledge memory by using the estimated domain and task.

The modulator may be configured to sum the modulation information directly acquired from the modulation information acquirer and the modulation information acquired from the knowledge memory, and modulate the initial parameter of the task execution model based on the summed modulation information.

According to still yet another aspect of the present invention, there is provided a program combined with a computer as hardware to execute an online Bayesian few-shot learning method in which the multi-domain-based online learning and few-shot learning are integrated and stored in a computer-readable recording medium.

Other specific details of the present invention are included in the detailed description and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a framework for online Bayesian few-shot learning according to an embodiment of the present invention;

FIG. 2 is a block diagram of an apparatus for online Bayesian few-shot learning according to an embodiment of the present invention;

FIG. 3 is a functional block diagram for describing the apparatus for online Bayesian few-shot learning according to the embodiment of the present invention; and

FIG. 4 is a flowchart of a method of online Bayesian few-shot learning according to an embodiment of the present invention.

### DETAILED DESCRIPTION OF EXEMPLARY EMBODIMENTS

Hereinafter, embodiments of the present invention will be described in detail with reference to the accompanying drawings so that those of ordinary skill in the art may easily implement the present invention. However, the invention may be implemented in various different forms and is not limited to the exemplary embodiments described herein. In the drawings, parts irrelevant to the description are omitted in order to clarify the description of the present invention.

Throughout the present specification, unless described to the contrary, the term “including any component” will be understood to imply the inclusion of other elements rather than the exclusion of other elements.

The present invention relates to a method and apparatus 100 for online Bayesian few-shot learning.

A few-shot learning technology is largely divided into a distance learning-based method and a gradient descent-based method.

The distance learning-based few-shot learning method is a method of learning a method of extracting a feature that makes a distance closer when two data categories are the same and makes the distance farther apart when the two data categories are different, and then selecting a category of the latest data in the feature space.

The gradient descent-based few-shot learning method is a method of finding initial values that show good performance by updating a small number of new tasks. For example, model agnostic meta-learning (MAML) is a representative method. This method has the advantage that it may be used in all models that are trained based on the gradient descent method, unlike other few-shot learning methods. However, since there is a problem that it is difficult to solve the problem of task ambiguity due to a small amount of data, it is preferable to provide a plurality of potential models without overfitting for ambiguous tasks. Accordingly, recently, Bayesian MALA, which utilizes uncertainty when learning a small amount of data, has been proposed.

An embodiment of the present invention provides the method and apparatus 100 for online Bayesian few-shot learning in which Bayesian few-shot learning and multi-domain online learning for an environment in which tasks having a small amount of data are sequentially given are integrated.

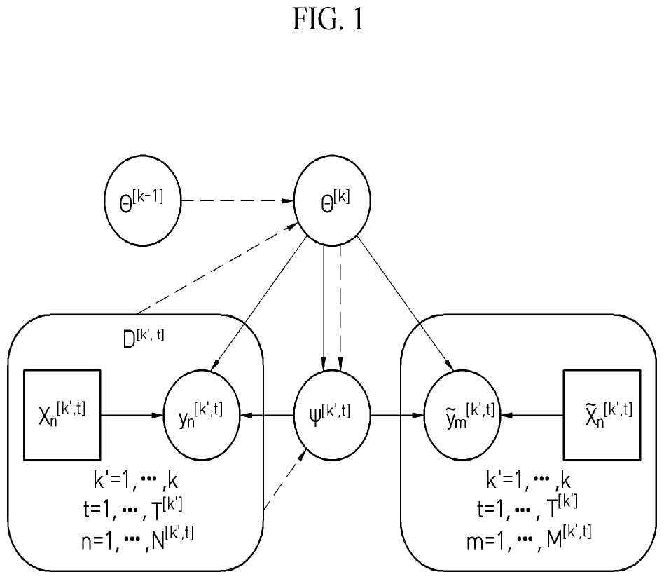

Hereinafter, the apparatus 100 for online Bayesian few-shot learning according to the embodiment of the present invention will be described with reference to FIGS. 1 to 3. First, a framework for the online Bayesian few-shot learning applied to the embodiment of the present invention will be described with reference to FIG. 1, and then the apparatus 100 for online Bayesian few-shot learning will be described.

FIG. 1 is a diagram for describing a framework for online Bayesian few-shot learning according to the embodiment of the present invention. In this case, in FIG. 1, a solid line represents an execution process, and a dotted line represents an inference process.

The framework for online Bayesian few-shot learning illustrated in FIG. 1 targets online Bayesian few-shot learning in a k^{th} domain.

The framework stores initial parameters of the entire model in a k−1^{st} domain for normalization-based online learning and stores some data of a past domain (1, 2, . . . , k−1^{st} domain) for rehearsal-based online learning.

In a t^{th} task of a k′^{th} domain, support data is denoted by (x^{k′,t}, y^{k′,t}) and query data is denoted by (\tilde{x}^{k′,t}, \tilde{y}^{k′,t}). In addition, in the t^{th} task of the k′^{th} domain, all pieces of the support data is denoted by D^{k′,t}={(x^{k′,t}, y^{k′,t})}, the initial parameters of the entire model are denoted by θ^{k}, and the adapted parameter of the task execution model is denoted by ψ^{k′,t}. In this case, a posterior prediction distribution of the input \tilde{x}^{k′,t} of the query data is as shown in Equation 1.

p(y^{k′,t}|\tilde{x}^{k′t},D^{k′,t})− [symbol] _{p(θ}_{^{k}}_{|\tilde{x}}_{^{k′,t}}_{,D}_{^{k′,t}}₎└ [symbol] _{p(ψ}_{^{k′,t}}_{|\tilde{x}}_{^{k′,t}}_{D}_{^{k′,t}}_{,θ}_{^{k}}₎[p(y^{k′,t}|\tilde{x}^{k′,t},D^{k′,t},ψ^{k′,t},θ^{k})]┘ [Equation 1]

Here, it is assumed that the initial parameters θ^{k} of the entire model and the adapted parameter ψ^{k′,t} of the task execution model do not depend on the input \tilde{x}^{k′,t} of the query data input, and all knowledge of all pieces of the support data D^{k′,t} is reflected in the adapted parameter ψ^{k′,t} of the task execution model.

In this case, when the probability distribution p(ψ^{k′,t}|\tilde{x}ₘ^{k′,t}, D^{k′,t}, θ^{k}) approximates a probability distribution q_{θ}^{k}(ψ^{k′,t}|D^{k′,t}, θ^{k}) modeled with a parameter ϕ^{k}, the probability distribution p(θ^{k}|\tilde{x}^{k′,t},D^{k′,t}) approximates a probability distribution q_{π}^{k} (θ^{k}|D^{k′,t}) modeled with a parameter π^{k}, and the probability distribution may be represented by the following Equation 2.

p(y^{k′,t}|\tilde{x}^{k′t},D^{k′t})≈ [symbol] _{q}_{_{π}}_{(k)(θ}_{^{k}}_{|D}_{^{k′t}}₎[ [symbol] _{q}_{_{φ}}_{(k)(ψ}_{^{k′t}}_{|D}_{^{k′t}}_{,θ}_{^{k}}₎[p(y^{k′t}|\tilde{x}^{k′t},ψ^{k′t},θ^{k})]] [Equation 2]

Meanwhile, the goal of the online Bayesian few-shot learning is to obtain an optimal parameter π^{k} and ϕ^{(k)} based on a loss function as a reference value. Here, the loss function L(π^{k},ϕ^{k}) may be represented using a mean of a posterior prediction log distribution of the input (\tilde{x}^{k′,t}) of the query data as shown in Equation 3.

$$[ Equation 3 ]$$

$$ℒ ( {π}^{k} , {ϕ}^{k} ) = {𝔼}_{p ( {D}^{{k}^{′} , t} , {\tilde{x}}^{{k}^{′} , t} , {y}^{{k}^{′} , t} )} [ log {𝔼}_{{q}_{π} ( k ) ( {θ}^{k} \vert {D}^{{k}^{′} , t} )} [ {𝔼}_{{q}_{ϕ} ( k ) ( {ψ}^{{k}^{′} , t} \vert {D}^{{k}^{′} , t} , {θ}^{k} )} [ p ( {y}^{{k}^{′} , t} \vert {\tilde{x}}^{{k}^{′} , t} , {ψ}^{{k}^{′} , t} , {θ}^{k} ) ] - {β}_{1} KL ( {q}_{ϕ} k ( {ψ}^{{k}^{′} , t} \vert {D}^{{k}^{′} , t} , {θ}^{k} ) \vert \vert p ( {ψ}^{{k}^{′} , t} \vert {D}^{{k}^{′} , t} , {θ}^{k} ) ) - {λ}_{1} KL ( {q}_{ϕ} k ( {ψ}^{{k}^{′} , t} \vert {D}^{{k}^{′} , t} , {θ}^{k} ) \vert \vert {q}_{{ϕ}^{k - 1}} ( {ψ}^{{k}^{′} , t} \vert {D}^{{k}^{′} , t} , {θ}^{k} ) ) ] - {β}_{2} KL ( {q}_{{π}^{k}} ( {θ}^{k} \vert {D}^{{k}^{′} , t} ) \vert \vert p ( {θ}^{k} \vert {D}^{{k}^{′} , t} ) ) - {λ}_{2} KL ( {q}_{{π}^{k}} ( {θ}^{k} \vert {D}^{{k}^{′} , t} ) \vert \vert {q}_{{π}^{k - 1}} ( {θ}^{k} \vert {D}^{{k}^{′} , t} ) ) ]$$

When the probability distribution q_{π}^{k}(θ^{k}|D^{k′,t}) is set by a dirac delta function and the adapted parameter ψ^{k′,t} of the task execution model is applied with the probabilistic gradient descent technique using the initial parameters θ^{k} of the entire model and all pieces of the support data D^{k′,t}, the loss function shown in Equation 3 may be simply represented as in Equation 4.

[symbol]

(π^{k},ϕ^{k})= [symbol] _{p(D}_{^{k′t}}_{,\tilde{x}}_{^{k′,t}}_{,y}_{^{k′t}}₎[log [symbol] _{q}_{_{π}}_{(k)(θ}_{^{k}}_{|D}_{^{k′t}}₎[ [symbol] _{q}_{_{ϕ}}_{(k)(ψ}_{^{k′t}}_{|D}_{^{k′t}}_{,θ}_{^{k}}₎[p(y^{k′t}|\tilde{x}^{k′t},104 ^{k′t},θ^{k})]]−λ₂KL(q_{π}_{^{k}}(θ^{k}|D^{k′t})∥q_{π}_{^{k-1}}(θ^{k}|D^{k′t}))] [Equation 4]

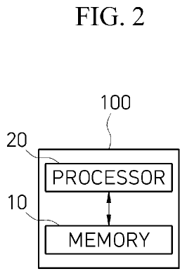

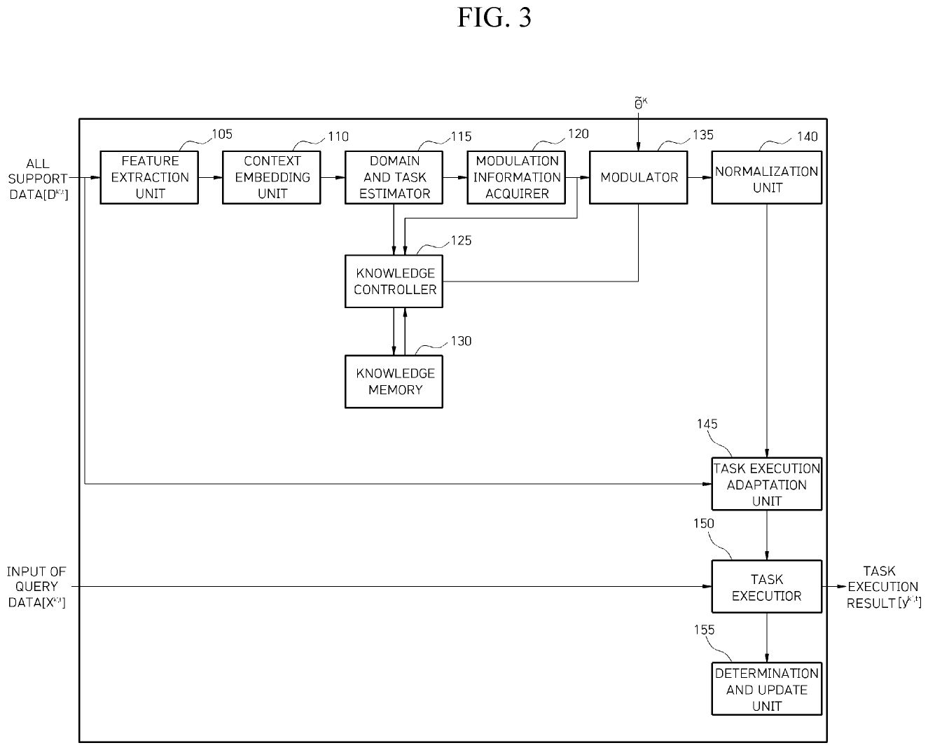

Hereinafter, a specific embodiment to which the framework for online Bayesian few-shot learning is applied will be described with reference to FIGS. 2 and 3.

FIG. 2 is a block diagram of the apparatus 100 for online Bayesian few-shot learning according to the embodiment of the present invention. FIG. 3 is a functional block diagram for describing the apparatus 100 for online Bayesian few-shot learning according to the embodiment of the present invention.

Referring to FIG. 2, the apparatus 100 for online few-shot learning according to the embodiment of the present invention includes a memory 10 and a processor 20.

Programs for the multi-domain-based online learning and the few-shot learning are stored in the memory 10. Here, the memory 10 collectively refers to a nonvolatile storage device and a volatile storage device that keeps stored information even when power is not being supplied.

For example, the memory 10 may include NAND flash memories such as a compact flash (CF) card, a secure digital (SD) card, a memory stick, a solid-state drive (SSD), and a micro SD card, magnetic computer storage devices such as a hard disk drive (HDD), and optical disc drives such as a compact disc-read only memory (CD-ROM) and a digital versatile disc-read only memory (DVD-ROM), and the like.

As the processor 20 executes the program stored in the memory 10, the processor 20 performs the functional elements illustrated in FIG. 3.

The apparatus 100 for online Bayesian few-shot learning according to the embodiment of the present invention uses a modulation method to cope with diverse domains and tasks sequentially given by increasing expressive power of the task execution model.

In order to use the modulation, it is necessary to extract features from all pieces of the support data D^{k′,t} in consideration of the context, estimate the domain and task, and calculate the modulation information directly or from the knowledge memory. In addition, the initial parameter \tilde{θ}^{k} of the task execution model is modulated and normalized through the calculated modulation information, and an adaptation process for task execution with all pieces of the support data D^{k′,t} is performed. Then, the task is performed using the adapted parameter ψ^{k′,t} of the task execution model to calculate the task execution loss. After calculating the total loss based on the task execution loss and the contrast loss, the initial parameters of the entire model are updated using the total loss as the reference value. In this case, the initial parameters θ^{k} of the entire model are divided into the initial parameter \tilde{θ}^{k} of the task execution model and a model parameter \tilde{θ}^{k} required to calculate the modulation information and the contrast loss.

The apparatus 100 for online Bayesian few-shot learning includes a feature extraction unit 105, a context embedding unit 110, a domain and task estimator 115, a modulation information acquirer 120, a modulator 135, a normalization unit 140, a task execution adaptation unit 145, a task executor 150, and a determination and update unit 155.

Specifically, the feature extraction unit 105 performs batch sampling based on at least one task in the previous domain and the current domain and then extracts features of all pieces of the support data D^{k′,t} corresponding to each sampled task.

For example, when the support data is composed of an image and a classification label (dog, cat, elephant, etc.), the feature extraction unit 105 may construct a module using a multi-layer convolutional neural network-batch normalization-nonlinear function having strength in image processing, set an image as the input of the module to obtain an output, and then concatenate a label to extract features.

The context embedding unit 110 performs embedding in consideration of the context information of the features extracted by the feature extraction unit 105.

In one embodiment, the context embedding unit 110 may set the extracted feature as an input of a self-attention model composed of multi-layers that considers correlation between inputs and acquire the embedded feature information as an output corresponding to the input.

In addition, the context embedding unit 110 may set the extracted features as an input of a bidirectional long short-term memory (BiLSTM) model composed of multi-layers and acquire the embedded feature information as the output corresponding to the input.

The domain and task estimator 115 estimates domains and tasks of all pieces of the input support data D^{k′,t} based on the embedded feature information according to the embedding result.

In one embodiment, the domain and task estimator 115 may set the embedded feature information as an input of a multi-layer perceptron model and acquire the estimated domain and task of the support data as the output corresponding to the input. In this case, a dimension of an output stage for an output of the multi-layer perceptron model may be set to be smaller than that of an input stage for input.

The modulation information acquirer 120 acquires the modulation information of the initial parameter \tilde{θ}^{k} of the task execution model based on the estimated domain and task.

In one embodiment, the modulation information acquirer 120 may acquire the modulation information of the initial parameter \tilde{θ}^{k} of the task execution model from the knowledge memory 130 using the estimated domain and task directly from the estimated domain and task or through a knowledge controller 125.

The knowledge controller 125 may acquire and store modulation information of the initial parameter \tilde{θ}^{k} of the task execution model from the knowledge memory 130 by using the estimated domain and task. In this case, the knowledge controller 125 sets the estimated domain and task as the input of the BiLSTM model or the multi-layer perceptron model and generates a read_query and a write_query required for accessing the knowledge memory 130 as the output corresponding to the input.

The knowledge controller 125 may calculate a weight for a location of the knowledge memory 130 to be accessed with cosine similarity using the read_query and acquire the modulation information of the initial parameter \tilde{θ}^{k} of the task execution model by a linear combination with a value stored in the knowledge memory through the weight.

In addition, the knowledge controller 125 may calculate the weight for the location of the knowledge memory 130 to be written with the cosine similarity using the write_query, delete the value stored in the knowledge memory 130 based on the calculated weight, and add the modulation information of the estimated domain and task, thereby updating the knowledge memory 130.

In addition, in one embodiment, the modulation information acquirer 120 may set the estimated domain and task as the input of a multi-layer perceptron model and then acquire the modulation information of the initial parameter \tilde{θ}^{k} of the task execution model as the output. In this case, the dimension of the output may match the dimension of the parameter \tilde{θ}^{k} of the task execution model.

The modulator 135 modulates the initial parameter \tilde{θ}^{k} of the task execution model based on the modulation information. In this case, the modulator 135 may sum the modulation information directly acquired by the modulation information acquirer 120 and the modulation information acquired from the knowledge memory 130 by the knowledge controller 125 and may modulate the initial parameter \tilde{θ}^{k} of the task execution model based on the summed modulation information.

For example, when the task execution model uses the convolutional neural network, the modulator 135 multiplies the modulation information by a channel parameter of the task execution model. In this case, when initial parameters of task execution models of a c-th channel, a h-th height, and a w-th width are denoted by \tilde{θ}_{c,h,w}^{k} and modulation information of the c-th channel is denoted by S_{c} and b_{c}, the parameter of the modulated model may be represented as in Equation 5. Here, s_{c} represents a variable size constant.

\tilde{θ}′_{c,h,w}=s_{c}·\tilde{θ}_{c,h,w}^{k}+b_{c} [Equation 5]

As another example, the modulator 135 may use a convolution filter other than a one-dimensional constant as the modulation information. In this case, when the initial parameter of the task execution model of the c-th channel is denoted by \tilde{θ}_{c}^{k}, the modulator 135 may perform the modulation by performing the convolution as shown in Equation 6. Here, S_{c} denotes a convolution filter.

\tilde{θ}′_{c}=s_{c}*\tilde{θ}_{c}^{k}+b_{c} [Equation 6]

The normalization unit 140 normalizes the parameter of the modulated task execution model. For example, the normalization unit 140 sets and normalizes the parameter size of the task execution model modulated for each channel as 1 as shown in Equation 7. In this case, ϵ is a term to prevent a division by zero.

$${\tilde{θ}}_{c , h , w}^{″} = \frac{\tilde{θ} {′}_{c , h , w}^{2}}{\sqrt{{\sum }_{h , w} \tilde{θ} {′}_{c , h , w}^{2} + ∈}} \qquad [ Equation 7 ]$$

The task adaptation unit adapts a parameter \tilde{θ}″ of the task execution model normalized by the normalization unit 140 to all pieces of the support data D^{k′,t}. In one embodiment, the normalization unit 140 may adapt the parameter \tilde{θ}″ of the normalized task execution model to all pieces of the support data D^{k′,t} based on the probabilistic gradient descent method.

The task executor 150 calculates the task execution loss by performing the task on the input of the query data using the adapted parameter ψ^{k′,t} of the task execution model.

In one embodiment, the task executor 150 may perform the task by applying the Bayesian neural network to the input of the query data. In this case, coefficients of the Bayesian neural network are set to a Gaussian distribution whose covariance is a diagonal matrix. Also, the adapted parameter ψ^{k′,t} of the task execution model is composed of a covariance and a mean. The task executor 150 samples the coefficients of the neural network from the Gaussian distribution and then applies the Bayesian neural network to the input of the query data, thereby outputting the result.

The determination and update unit 155 acquires a logit pair for all pieces of the support data and the input of the query data and calculates the contrast loss based on the acquired logit pair.

In one embodiment, the determination and update unit 155 may acquire a logit pair for the support data and the input ({\tilde{x}ᵢ^{k′,t}}_{i=1, . . . , M}) of the query data as the initial parameters of the entire model of the previous domain and the current domain consecutive to the previous domain.

In addition, the determination and update unit 155 may determine whether or not the acquired logit pair is generated as the same data and calculate the contrast loss based on an error according to the determination result.

For example, when each of the logits for the input of the support data and i^{th} query data as the initial parameters θ^{k-1}, θ^{k} of the entire model in the k−1^{st} domain and the k^{th} domain is denoted by Tᵢ and Sᵢ, the determination and update unit 155 acquires the logit pair ({(Tᵢ,Sⱼ)}_{i,j=1, . . . , M}) for the input of M query data. It is determined whether or not the logit pair is generated with the same query data using the multi-layer perceptron model. The error due to the determination corresponds to the contrast loss, and the learning is performed to easily reduce the contrast loss in terms of interdependence information.

To this end, the determination and update unit 155 calculates a total loss based on the task execution loss and the contrast loss and updates the initial parameters θ^{k} of the entire model based on the total loss. In this case, the determination and update unit 155 may update the initial parameters θ^{k} of the entire model with a backpropagation algorithm using the total loss as the reference value.

For reference, the components illustrated in FIGS. 2 and 3 according to the embodiment of the present invention may be implemented in software or in hardware form, such as a field programmable gate array (FPGA) or an application specific integrated circuit (ASIC), and may perform predetermined roles.

However, “components” are not limited to software or hardware, and each component may be configured to be in an addressable storage medium or configured to reproduce one or more processors.

Accordingly, as one example, the components include components such as software components, object-oriented software components, class components, and task components, processors, functions, attributes, procedures, subroutines, segments of a program code, drivers, firmware, a microcode, a circuit, data, a database, data structures, tables, arrays, and variables.

Components and functions provided within the components may be combined into a smaller number of components or further separated into additional components.

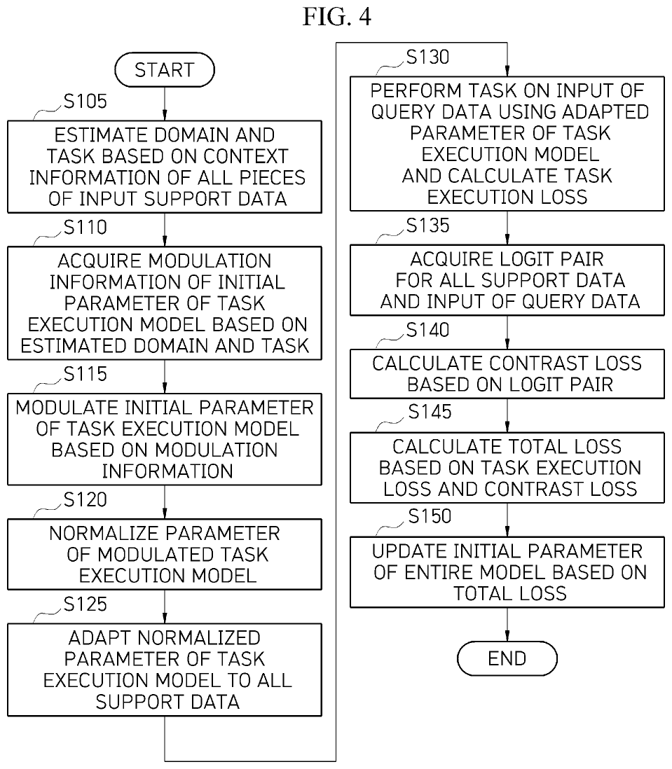

Hereinafter, the method performed by the apparatus 100 for online Bayesian few-shot learning according to the embodiment of the present invention will be described with reference to FIG. 4.

FIG. 4 is a flowchart of the method for online Bayesian few-shot learning.

First, when the domain and task are estimated based on the context information of all pieces of the input support data (S105), the modulation information of the initial parameter of the task execution model is acquired based on the estimated domain and task (S110).

Next, the initial parameter of the task execution model is modulated based on the modulation information (S115), and the modulated parameter of the task execution model is normalized (S120), and then the normalized parameter of the task execution model performs the adaptation to all pieces of the support data (S125).

Next, the task execution loss is calculated by performing the task on the input of the query data using the adapted parameter of the task execution model (S130), and the logit pair for the input of all pieces of the support data and the query data is acquired (S135).

Next, after the contrast loss is calculated based on the acquired logit pair (S140), the total loss is calculated based on the task execution loss and the contrast loss (S145), and then the total loss is used as the reference value to update the initial parameter (S150).

In the above description, operations S110 to S150 may be further divided into additional operations or combined into fewer operations, according to the implementation example of the present invention. Also, some operations may be omitted if necessary, and the order between the operations may be changed. In addition, even if other contents are omitted, the contents already described in FIGS. 1 to 3 are also applied to the method for information online Bayesian few-shot learning of FIG. 4.

An embodiment of the present invention may be implemented in the form of a computer program stored in a medium executed by a computer or a recording medium including instructions executable by the computer. Computer-readable media may be any available medium that may be accessed by the computer and includes both volatile and nonvolatile media and removable and non-removable media. Further, the computer-readable media may include both computer storage media and communication media. Computer storage media includes both the volatile and nonvolatile and the removable and non-removable media implemented in any method or technology for storage of information such as computer readable instructions, data structures, program modules, or other data. Communication media typically includes computer readable instructions, data structures, program modules, other data in a modulated data signal such as a carrier wave, or other transmission mechanism, and includes any information transmission media.

The method and system according to the present invention have been described in connection with the specific embodiments, but some or all of their components or operations may be implemented using a computer system having a general-purpose hardware architecture.

According to one of the embodiments of the present invention, it is possible to integrate online learning and few-shot learning, in which domains of tasks having a small amount of data are sequentially given and effectively utilize context information of input data to accurately estimate the domains and tasks.

In addition, by using a memory for modulation information as a knowledge memory, it is possible to not only use previously executed knowledge but also to update newly executed knowledge.

In addition, it is possible to expect high performance in various domains given sequentially by increasing expressive power of a model through a modulation of task execution model parameters and to utilize more information present in data by applying a contrast loss.

The effects of the present invention are not limited to the above-described effects, and other effects that are not described may be obviously understood by those skilled in the art from the above detailed description.

It can be understood that the above description of the invention is for illustrative purposes only, and those skilled in the art to which the invention belongs can easily convert the invention into another specific form without changing the technical ideas or essential features of the invention. Therefore, it should be understood that the above-described embodiments are exemplary in all aspects but are not limited thereto. For example, each component described as a single type may be implemented in a distributed manner, and similarly, components described as distributed may be implemented in a combined form.

It is to be understood that the scope of the present invention will be defined by the claims to be described below and all modifications and alternations derived from the claims and their equivalents are included in the scope of the present invention.

What is claimed is:

1. A method of online Bayesian few-shot learning, in which multi-domain-based online learning and few-shot learning are integrated and which is executed by a computer, the method comprising:
estimating a domain and a task based on context information of all pieces of input support data;
acquiring modulation information of an initial parameter of a task execution model based on the estimated domain and task;
modulating the initial parameter of the task execution model based on the modulation information;
normalizing the modulated parameter of the task execution model;
adapting the normalized parameter of the task execution model to all pieces of the support data;
calculating a task execution loss by performing a task on an input of query data using the adapted parameter of the task execution model;
acquiring a logit pair for all pieces of the support data and the input of the query data;
calculating a contrast loss based on the acquired logit pair;
calculating a total loss based on the task execution loss and the contrast loss; and
updating the initial parameters of the entire model using the total loss as a reference value.

2. The method of claim 1, wherein the estimating of the domain and task based on the context information of all pieces of the input support data includes;
performing batch sampling based on at least one task in a previous domain and a current domain consecutive to the previous domain;
extracting features of the support data corresponding to each of the sampled tasks;
performing embedding in consideration of context information of the extracted features; and
estimating the domain and the task of the support data based on embedded feature information according to an embedding result.

3. The method of claim 2, wherein the performing of the embedding in consideration of the context information of the extracted features includes:
setting the extracted feature as an input of a self-attention model composed of multi layers; and
acquiring the embedded feature information as an output corresponding to the input.

4. The method of claim 2, wherein the performing of the embedding in consideration of the context information of the extracted features includes:
setting the extracted feature as an input of a bidirectional long short-term memory (BiLSTM) model composed of the multi layers; and
acquiring the embedded feature information as the output corresponding to the input.

5. The method of claim 2, wherein the estimating of the domain and the task of the support data based on the embedded feature information according to the embedding result includes:
setting the embedding feature information as an input of a multi-layer perceptron model; and
acquiring the area and the task of the estimated support data as the output corresponding to the input, and
a dimension of an output stage for the output is set to be smaller than a dimension of an input stage for the input.

6. The method of claim 1, wherein the acquiring of the modulation information of the initial parameter of the task execution model based on the estimated domain and task includes acquiring the modulation information of the initial parameter of the task execution model from a knowledge memory by using the estimated domain and task.

7. The method of claim 6, wherein the acquiring of the modulation information of the initial parameter of the task execution model based on the estimated domain and task includes:
setting the estimated domain and task as an input of a bidirectional long short-term memory (BiLSTM) model or a multi-layer perceptron model; and
generating a read_query and a write_query required for accessing the knowledge memory as an output corresponding to the input.

8. The method of claim 7, wherein the acquiring of the modulation information of the initial parameter of the task execution model based on the estimated domain and task includes:
calculating a weight for a location of the knowledge memory using the read_query; and
acquiring the modulation information of the initial parameter of the task execution model by a linear combination with a value stored in the knowledge memory through the weight.

9. The method of claim 7, wherein the calculating of the weight for the location of the knowledge memory using the read_query further includes deleting the value stored in the knowledge memory based on the weight, and adding and updating the modulation information of the estimated domain and task.

10. The method of claim 1, wherein the acquiring of the modulation information of the initial parameter of the task execution model based on the estimated domain and task includes acquiring the modulation information of the initial parameter of the task execution model from the estimated domain and task.

11. The method of claim 1, wherein the modulating of the initial parameter of the task execution model based on the modulation information is performed using a variable size constant or a convolution filter as the modulation information.

12. The method of claim 1, wherein the adapting of the normalized parameter of the task execution model to all pieces of the support data includes performing the adaptation of the normalized parameter of the task execution model to all pieces of the support data based on a probabilistic gradient decent method.

13. The method of claim 1, wherein the performing of the task on the input of the query data using the adapted parameter of the task execution model includes performing the task by applying a Bayesian neural network to the input of the query data.

14. The method of claim 1, wherein the acquiring of the logit pair for all pieces of the support data and the input of the query data includes acquiring the logit pair for all pieces of the support data and the input of the query data as the initial parameters of the entire model of the previous domain and a current domain consecutive to the previous domain.

15. The method of claim 1, wherein the calculating of the contrast loss based on the acquired logit pair includes:
determining whether the acquired logit pair is generated as the same data; and
calculating the contrast loss based on an error according to the determination result.

16. An apparatus for online Bayesian few-shot learning in which multi-domain-based online learning and few-shot learning are integrated, the apparatus comprising:
a memory in which a program for multi-domain-based online learning and few-shot learning is stored, and
a processor configured to execute the program stored in the memory,
wherein the processor is configured to estimate a domain and a task based on context information of all pieces of input support data, and acquire modulation information of an initial parameter of a task execution model based on the estimated domain and task, and then modulate the initial parameter of the task execution model based on the modulation information according to an execution of the program,
normalize the parameter of the modulated task execution model, adapt the normalized parameter to all pieces of the support data, and calculate a task execution loss by performing the task on the input of the query data using the adapted parameter of the task execution model, and
acquire a logit pair for all pieces of the support data and the input of the query data, calculate a contrast loss based on the acquired logit pair, calculate a total loss based on the task execution loss and the contrast loss, and then update the initial parameters of the entire model using the total loss as a reference value.

17. An apparatus for online Bayesian few-shot learning in which multi-domain-based online learning and few-shot learning are integrated, the apparatus comprising:
a domain and task estimator configured to estimate a domain and a task based on context information of all pieces of input support data;
a modulation information acquirer configured to acquire modulation information of an initial parameter of a task execution model based on the estimated domain and task;
a modulator configured to modulate the initial parameter of the task execution model based on the modulation information;
a normalization unit configured to normalize the modulated parameter of the task execution model;
a task execution adaptation unit configured to adapt the normalized parameter of the task execution model to all pieces of the support data;
a task executor configured to calculate a task execution loss by performing a task on an input of query data using the adapted parameter of the task execution model; and
a determination and update unit configured to acquire a logit pair for all pieces of the support data and the input of the query data, calculate a contrast loss based on the acquired logit pair, calculate a total loss based on the task execution loss and the contrast loss, and then update the initial parameters of the entire model using the total loss as a reference value.

18. The apparatus method of claim 17, wherein the modulation information acquirer acquires the modulation information of the initial parameter of the task execution model directly from the estimated domain and task or from a knowledge memory by using the estimated domain and task.

19. The apparatus of claim 18, wherein the modulator is configured to sum the modulation information directly acquired from the modulation information acquirer and the modulation information acquired from the knowledge memory and modulate the initial parameter of the task execution model based on the summed modulation information.
